(19) United States
(12) Patent Application Publication
(10) Pub. No.: US 2026/0308496 A1
(43) Pub. Date: Oct. 8, 2026

(54) COMPOSITION AND METHOD FOR MAKING DISTILLED SPIRIT

(71) Applicant: BROTHER JUSTUS WHISKEY CO., Minneapolis, MN (US)

(72) Inventors: Philip Joseph Steger, St. Paul, MN (US); James Jefferson, St. Paul, MN (US); Craig A. Blum, New Brighton, MN (US); Alec Prince, Minneapolis, MN (US)

(21) Appl. No.: 19/483,453

(22) PCT Filed: May 10, 2024
(86) PCT No.: PCT/US2024/028826

§ 371 Date: Nov. 11, 2025

Related U.S. Application Data
(60) Provisional application No. 63/466,059, filed on May 12, 2023.

(51) Int. Cl. C12H 6/02; C12G 3/07; C12H 1/07; C12H 1/22

(52) U.S. Cl. CPC C12H 6/02; C12G 3/07; C12H 1/063; C12H 1/22

(57) ABSTRACT

A method for making a distilled spirit includes distilling a liquor comprising alcohol to form a distilled liquor; and contacting the distilled liquor with peat. The peat may include peat dry matter. The peat may include dried peat. The peat may include partially charred peat. The peat may include 50 wt-% or less of inorganic carbon on a dry weight basis. The peat may be arranged in a filter housing. The distilled liquor may be contacted with the peat for at least 5 seconds. A composition includes distilled liquor comprising alcohol and water; and peat. The peat may include peat dry matter. The peat may include dried peat. The peat may include partially charred peat. The peat may include 50 wt-% or less of inorganic carbon on a dry weight basis. The composition may include 40 vol-% or more of alcohol based on liquid components of the composition.

### RELATED APPLICATIONS

This application claims priority to U.S. Provisional Patent Application No. 63/466,059, filed on May 12, 2023, which is incorporated by reference herein in its entirety.

### FIELD

The present disclosure relates to a composition and method for making a distilled spirit.

### BACKGROUND

A typical process for making whiskey includes malting grains (usually barley) by hydrating the grains with water and then allowing the grains to partially germinate to activate enzymes naturally present in the grains. In addition to barley, other grains may also be used or added, such as wheat, rye, or corn. The grains may be malted or not malted. After a few days of germination, the grains are dried at low heat to stop germination, while preserving the enzymes. In some cases, the grains are flavored using smoke from a fire during drying. In particular, traditional Scottish Highland and Islay whiskeys may be flavored by peat smoke generated by adding peat to the fire during drying of the malted grain. Thus, the term “peaty” or “peated” traditionally refers to a smoky flavor profile due to smoke from the fire that has peat added to it.

The dried malt is usually milled and then mashed by mixing with hot water and allowing the enzymes to convert starches into sugars. The remaining grains may be removed from the process liquid known as wort. The wort is cooled and mixed with yeast to initiate fermentation. Fermentation is allowed to progress until a desired alcohol level is reached, ranging at the low end from 6-8 vol-% to as high as 18-20 vol-% depending on the yeast and fermentation conditions.

The fermented liquor is distilled to purify and concentrate the alcohol, as well as to refine and concentrate the flavors. The liquor is typically distilled to a strength of about 65-70 vol-%, but may be distilled to a strength as high as of about 85-90 vol-%, and afterwards adjusted down to cask strength (typically between 58 vol-% and 62 vol-%) by adding water. The liquor is then brought to contact with oak (or other wood) and may be aged in casks anywhere from a few months to several years, turning the distilled liquor into whiskey. Traditionally, oak casks or barrels are used for aging. The inside surface of the cask may be charred.

### SUMMARY

A method for making a distilled spirit includes distilling a liquor comprising alcohol to form a distilled liquor; and contacting the distilled liquor with peat by: arranging the peat in a filter cartridge; and recirculating the distilled liquor through the peat to achieve a total dosage of 5 w/v-% or greater of peat to distilled liquor.

A method for making a distilled spirit includes distilling a liquor comprising alcohol to form a distilled liquor; and contacting the distilled liquor with peat by: mixing a first amount of peat with the distilled liquor; mixing a second amount of peat with the distilled liquor; and separating at least a majority of the first and second amounts of peat from the distilled liquor.

The peat may include peat dry matter. The peat may include dried peat. The peat may include partially charred peat. The peat may include 50 wt-% or less of inorganic carbon on a dry weight basis. The distilled liquor may be contacted with the peat for at least 5 seconds.

A composition includes distilled liquor comprising alcohol and water; and peat. The peat may include peat dry matter. The peat may include dried peat. The peat may include partially charred peat. The peat may include 50 wt-% or less of inorganic carbon on a dry weight basis. The composition may include 40 vol-% or more of alcohol based on liquid components of the composition.

### DETAILED DESCRIPTION

The present disclosure relates to a composition and method for making a distilled spirit. The present disclosure further relates to a composition and method for making distilled alcoholic beverage from malted or non-malted grain or other crops. In particular, the present disclosure relates to a composition and method for preparing a distilled alcoholic beverage with a peat flavor, and more particularly, a whiskey with peat flavor.

The term “peat” is used in this disclosure to describe a material harvested from a peatland, mire, or bog, that includes incompletely decomposed organic plant material (humus), such as reeds and sedges and to such harvested material that has been treated or processed, for example by heating, provided that the treated or processed peat retains peat flavor.

The term “peat flavor” is used here to describe a flavor profile that includes at least some components of peat. For example, the flavor profile may include certain resins, sterols, fatty acids, hydroxy acids, alkanes, long-chain alcohols, phenolic acids, and terpenoids typically found in peat. The peat flavor produced by the methods of the present disclosure is distinguished from a traditional “peaty” or “peated” flavor which is distinctly smoky due to the use of smoke from a fire to which peat has been added.

The term “inorganic carbon” is used in this disclosure to describe elemental carbon (e.g., graphite and carbon black) and various inorganic carbon species. Inorganic carbon may be the product of carbonization. Activated carbon and charcoal are understood to contain high amounts of inorganic carbon, such as 50 wt-% or greater or 75 wt-% or greater.

The term “hardness” is used in this disclosure to refer to a material's ability to resist attrition during handling and operation. Hardness may be given as a “hardness number” and determined by the Ball-Pan Hardness test. In the Ball-Pan Hardness test, a certain amount of material is put into a pan, together with some steel balls, and shaken for a defined period of time. The material is weighed before and after the shaking to determine the amount of attrition. The percent of original material that remains after shaking is the “hardness number.” ASTM D3802-16 Standard Test Method for Ball-Pan Hardness of Activated Carbon, which is directed to activated carbon, may be modified and employed to test hardness of peat granules.

The term “alcohol” is used in this disclosure to refer to ethyl alcohol (ethanol) unless otherwise stated.

The term “alcohol-extracted peat compound” is used in this disclosure to refer to a compound that is transferred from peat to a solvent in contact with the peat, where the solvent includes alcohol. Preferably, the alcohol-extracted peat compound is extracted from the peat by contacting the peat with distilled liquor. The distilled liquor may have an alcohol concentration of 50 vol-% or greater, 60 vol-% or greater, 70 vol-% or greater, or 80 vol-% or greater. Preferably, the peat is in solid form, such as dried granulated peat.

The term “sensory panel” is used to refer to a group of panelists that are experienced taste testers. A sensory panel may be used to evaluate the flavor profile and aromas of a product. A sensory panel may use sensory methodologies such as descriptive analysis and may utilize a scale of intensity to describe certain sensory attributes. The panelists of a sensory panel are typically experienced tasters familiar with the sensory attributes being tested. A trained panelist may have undergone training to understand the terms and sensory phenomena associated with the sensory attributes relevant to the tested product and may be familiar with the use of common descriptors for those sensory attributes of interest (i.e., a sensory lexicon). Panelists may evaluate samples in replicate and may be blinded to the samples they are testing. Samples being tested may be provided to the panelists randomly or in a sequential order.

The term “flavor” refers to the taste and retronasal perception in the nasal cavity. The term “finish” in the context of tasting refers to the aftertaste or flavors that are experienced after swallowing. The finish forms a part of a full retronasal olfactory experience.

The term “substantially” as used here has the same meaning as “significantly,” and can be understood to modify the term that follows by at least about 75%, at least about 90%, at least about 95%, or at least about 98%. The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood have the same meaning as “approximately” and to cover a typical margin of error, such as +5% of the stated value.

Terms such as “a,” “an,” and “the” are not intended to refer to only a singular entity but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

Embodiments of the present disclosure relate to methods of preparing a distilled spirit or alcoholic beverage suitable for human consumption. According to some embodiments, the distilled spirit is prepared by fermentation of a grain or other crop to produce a fermented liquor containing alcohol, and by distilling the fermented liquor. Distillation may be used to concentrate the alcohol in the liquor. Distillation may also be used to remove undesired fractions and/or to concentrate desired flavor compounds. The distilled spirit is infused with peat. The distilled spirit may be infused with peat without imparting smokiness or smoky flavor to the distilled spirit. The present disclosure provides methods of preparing a peat infused distilled spirit. The present disclosure provides methods of preparing a peat infused whiskey. The present disclosure further provides peat infused distilled spirits. The present disclosure provides a peat infused whiskey.

It has been discovered that when larger batches are processed using methods suitable for flavoring small batches of distilled spirits with peat, the method may not impart the desired flavor profile to the larger batches even when the same relative amount of peat is used. Simply adding more peat to the distilled spirit to intensify the flavor may not be desirable due to processing constraints and/or cost. Thus, improvements to methods of imparting peat flavor to distilled spirits are desired. Methods suitable for flavoring small batches of distilled spirits may be adjusted to impart a desired flavor profile to larger batches.

The crop used to prepare the fermented liquor may include any suitable grain or mixture of grains. Suitable grains may include barley, wheat, rye, oat, corn, sorghum, rice, etc., and combinations thereof. Other starch- or sugar-containing plant materials may also be used, such as potatoes, grapes, sugarcane, sugar beets, agave, etc. In some embodiments the grain includes barley. The grain may be malted or non-malted or may include a mixture of malted and non-malted grains.

According to an embodiment, a distilled liquor or distilled spirit is prepared by distilling a fermented liquor containing alcohol. The terms distilled liquor and distilled spirit are used herein interchangeably and may refer to either an intermediate product or a final product. The distilled liquor may be contacted with peat to impart a peat flavor to the distilled liquor or distilled spirit. In some embodiments, the distilled liquor is whiskey. In other embodiments, the distilled liquor includes gin, vodka, brandy, or the like. Further, in some embodiments the distilled liquor is a whiskey with peat flavor, a gin with peat flavor, a vodka with peat flavor, or a brandy with peat flavor.

According to an embodiment, the peat infused distilled liquor or peat infused distilled spirit is free or substantially free of smoke. According to an embodiment, the peat infused distilled liquor or peat infused distilled spirit is free or substantially free of smoke flavor. According to an embodiment, the method of making the peat infused distilled liquor or peat infused distilled spirit does not include contacting the distilled liquor or distilled spirit with smoke. According to an embodiment, the method of making the peat infused distilled liquor or peat infused distilled spirit does not include contacting the distilled liquor or distilled spirit with smoke flavor. Smoke and smoke flavor are understood to include not only natural smoke produced by burning or pyrolyzing biomass, but also flavorants and concentrates, such as products known as “liquid smoke” or “peat smoke.” Liquid peat smoke flavoring may also be sold as “peat extract.” In contrast, the peat infused distilled liquor or peat infused distilled spirit of the present disclosure is made by contacting a distilled liquor with peat solids.

Any suitable peat material may be used in the method. Peat sourced from different geographical locations may exhibit different botanical, hydrological, and mineral properties and may impart a different flavor profile. The peat used in the method may be selected to result in a desired flavor profile. For example, peat from a temperate or continental climate peatland, such as those found in the U.S. Midwest (e.g., Minnesota), may be used.

The peat may include peat dry matter. Peat dry matter may be described as the solid constituents of peat other than water and volatile matter, and may include, for example, cellulose, hemicellulose, lignin, humic substances, resins, nitrogen-containing compounds, minerals, etc. The peat may include dried, compressed, pelletized, granulated, ground, or otherwise suitably processed peat. The peat may be processed using methods disclosed in U.S. Pat. No. 8,232,225 to Green et al., incorporated here in its entirety. The peat may include peat granules with a hardness of about 50% to about 100%, or from about 75% to about 100%. Using peat granules treated to have sufficient hardness (e.g., 50% or greater or 75% or greater) may be beneficial for processing the distilled liquor. In some embodiments, the peat is processed so that the peat does not substantially dissolve in the distilled liquor. In some embodiments, the peat includes peat dried at a high heat, such as at temperatures ranging from 200° F. (about 93° C.) to about 1000° F. (about 540° C.). The peat may be dried using a temperature profile that includes a combination of lower temperatures (e.g., 180° F. to 300° F.) and higher temperatures (e.g., 800° F. to 900° F.). During one or more of the process steps (for example, during exposure to higher temperatures ranging from 500° F. to 900° F.) the peat may be exposed to a low-oxygen environment. For example, the peat may be exposed to a stream of an inert gas, such as carbon dioxide or nitrogen. The peat may include partially charred peat. However, in at least some embodiments, the peat contains 5 wt-% or less, 10 wt-% or less, 25 wt-% or less, or 50 wt-% or less of inorganic carbon (e.g., carbonized carbon due to charring) on a dry weight basis. In some embodiments, the peat is raw (untreated) peat or minimally treated peat. Minimal treatment may include, for example, filtration to remove water, compression, drying at a low (e.g., 300° F. or lower) temperature, particle size reduction, or a combination thereof. Some of the treatments may result in at least partial polymerization of some components of the peat. The dried peat may have a moisture (i.e., water) content of 70 wt-% or less, 50 wt-% or less, 35 wt-% or less, 25 wt-% or less, 20 wt-% or less, or 15 wt-% or less prior to being contacted with the distilled liquor. In some embodiments, the peat has a moisture content of 1 wt-% or more, 2 wt-% or more, 5 wt-% or more, 10 wt-% or more, 20 wt-% or more, or 30 wt-% or more prior to being contacted with the distilled liquor. While moisture, as used herein, generally refers to water, some other compounds (e.g., volatile compounds) may be measured as moisture content, for example, where weighing and drying techniques are used to measure moisture content. The peat may also be treated to modify the flavor profile of the peat, for example, by selectively removing or reducing the amount of one or more flavor compounds found in raw peat. Examples of peat flavor compounds that may be modified, removed, reduced, or enhanced include certain resins, sterols, fatty acids, hydroxy acids, alkanes, long-chain alcohols, phenolic acids, and terpenoids typically found in peat. Some such compounds may be polymerizable, and may be at least partially polymerized during treatment of the peat.

The distilled liquor may be contacted with peat in any suitable manner. For example, the peat may be dispersed in the distilled liquor, or the distilled liquor may be flown (e.g., filtered) through the peat. In some embodiments the peat is arranged in a filter cartridge or filter bag, and the distilled liquor is passed through the peat within the filter cartridge or filter bag. The structures forming a filter cartridge, filter bag, or other filter arrangements may be collectively referred to as filter housing here. An amount of peat may first be pre-wetted prior to placing into the filter cartridge or filter bag. For example, the amount of peat may be soaked in a liquid such that the peat is saturated by the liquid and expands to form a mixture of peat and liquid (e.g., a peat suspension, a peat slurry, etc.). The peat may be pre-wetted, for example, with the distilled liquor or with water. The filter cartridge or filter bag may include a filter that helps keep the peat solids within the filter. The filter may have a suitable nominal pore size, such as 10 μm to 100 μm, or about 20 μm.

In embodiments where the peat is arranged in a filter cartridge or filter bag (e.g., a filter housing), the distilled liquor may be recirculated through the peat. The distilled liquor may be pumped through the filter at a suitable flow rate. The suitable flow rate may depend on various parameters, such as the size of the filter and the system in general, the pore size of the filter, and back pressure caused by the filter packed with peat. The distilled liquor may be circulated through the peat to achieve a desired amount of exposure of the distilled liquor to the peat. For example, the distilled liquor may be recirculated through the peat to achieve a desired number of passes through the peat, such as about 3 passes or more, 4 passes or more, 5 passes or more, 6 passes or more, or 7 passes or more. The distilled liquor may be recirculated through the peat to achieve 20 passes or less, 15 passes or less, 12 passes or less, 10 passes or less, 8 passes or less, or 7 passes or less. The size of the filter and thus the peat bed may be adjusted to achieve a desired dosage rate with the number of passes. Dosage rates (which may be measured, for example, as weight of peat per volume of distilled liquor) are discussed elsewhere herein. In one exemplary embodiment, a batch of 450 gallons (about 1700 L) of distilled liquor is passed through a filter with 5 kg of peat at a flow rate of 5-7 gallons per minute (about 19-26 L/min) for 8 hours to achieve 7.5 passes at a dosage rate of 3 g/L per cycle or a total dosage (calculated by multiplying the dosage rate by the number of passes) of about 23 g/L.

In some embodiments, the distilled liquor is contacted with peat by first contacting the distilled liquor with a first amount of peat in a first contacting step and then contacting the distilled liquor with a second amount of peat in a second contacting step. The distilled liquor may further be contacted with a third, fourth, fifth, and subsequent amounts of peat in third, fourth, fifth, and subsequent contacting steps, respectively. The method of contacting the distilled liquor with the amount of peat may be the same or different for the first, second, and subsequent contacting steps. For example, in one or more of the contacting steps, the entire volume of distilled liquor may be contacted with the amount of peat, for example by mixing the volume of distilled liquor with the amount of peat. The mixture of distilled liquor and peat may optionally be mixed or agitated either intermittently during the contact time or for the entire duration of the contact time. In one or more of the contacting steps, a portion of the volume of distilled liquor may be contacted with the amount of peat, for example by mixing the portion of the volume of distilled liquor with the amount of peat for the duration of contact, removing the amount of peat, and mixing the portion of the volume of distilled liquor with the rest of the volume of distilled liquor. In one or more of the contacting steps, the volume of distilled liquor may be recirculated through a packed bed including the amount of peat. In one or more of the contacting steps, the volume of distilled liquor may have a first alcohol concentration when contacted with the amount of peat, and in another one or more of the contacting steps, the volume of distilled liquor may have a second, different alcohol concentration when contacted with the amount of peat.

The distilled liquor may be contacted with the peat for a contact time of 1 second or longer, 2 seconds or longer, 5 seconds or longer, 10 seconds or longer, 15 seconds or longer, 30 seconds or longer, 1 minute or longer, 10 minutes, 30 minutes or longer, 1 hour or longer, 6 hours or longer, 12 hours or longer, 24 hours or longer, 48 hours (2 days) or longer, 3 days or longer, 4 days or longer, or 1 week or longer. The distilled liquor may be contacted with the peat for a contact time of up to several weeks, such as for 4 weeks or less, 3 weeks or less, or 2 weeks or less. The distilled liquor may be contacted with the peat for 48 hours or less, 24 hours or less, 12 hours or less, 6 hours or less, 2 hours or less, 1 hour or less, 30 min or less, 10 min or less, 5 min or less, 3 min or less, 2 min or less, or 1 min or less. The distilled liquor may be contacted with the peat for a contact time of 1 second to 1 hour. The distilled liquor may be contacted with the peat for a contact time of 10 seconds to 30 minutes. The distilled liquor may be contacted with the peat for a contact time of 30 seconds to 10 minutes. The distilled liquor may be contacted with the peat for a contact time of 1 hour to 2 days, 1 hour to 30 hours, 1 hour to 24 hours, 1 hour to 12 hours, or 1 hour to 8 hours. The distilled liquor may be contacted with the peat for a contact time of 1 day to 3 weeks. The distilled liquor may be contacted with the peat for a contact time of 4 days to 20 days. The distilled liquor may be contacted with the peat for a contact time of 1 week to 2 weeks. In embodiments where the distilled liquor is contacted with two or more amounts of peat, each contacting step may have a contact time as discussed herein. The contact times of different contacting steps may be the same or different.

In some embodiments, the distilled liquor is contacted with peat by first contacting the distilled liquor with a first amount of peat for a first contact time and then contacting the distilled liquor with a second amount of peat for a second contact time. The first contact time may be the same or longer than the second contact time. In some embodiments, the first contact time is longer than the second contact time. For example, the first contact time may be 4 days or longer (e.g., 5 to 8 days) and the second contact time may be 1 to 3 days (e.g., 2 to 3 days). Alternatively, the shorter contact time may be the first contact time and the longer contact time may be the second contact time. The total contact time in this embodiment may be from 5 to 11 days or from 7 to 10 days. The first amount of peat may be removed from contact with the distilled liquor prior to contacting the distilled liquor with the second amount of peat. Alternatively, the first amount of peat may remain in contact with (e.g., mixed with) the distilled liquor during the second contact time while the distilled liquor is also contacted with the second amount of peat. The total amount (dosage) of peat may be 3 w/v-% or greater, 4 w/v-% or greater, 5 w/v-% or greater, or 6 w/v-% or greater of peat to distilled liquor. The total amount (dosage) of peat may be 15 w/v-% or less, 12 w/v-% or less, 10 w/v-% or less, 8 w/v-% or less, 7 w/v-% or less, 6 w/v-% or less, 5 w/v-% or less, or 4 w/v-% or less of peat to distilled liquor.

In some embodiments, the distilled liquor is contacted with an amount of peat, after which the peat solids are removed from the distilled liquor. The peat solids may then be mixed with water to extract further flavors from the peat. It should be noted that after contacting with the distilled liquor, the peat solids are wet with the distilled liquor. Thus, further mixing the peat solids that are wet with distilled liquor, with water will result in a mixture of peat solids, distilled liquor, and water. The peat solids may be mixed with water at a weight ratio of about 2:1 to 1:2, 1.5:1 to 1:1.5, or about 1:1, based on total weight of wet peat solids. The mixture may optionally be heated to an elevated temperature of 60° C. to 100° C., 80° C. to 100° C., or 90° C. to 99° C. This results in the formation of peat rinse water or peat-infused water. The peat rinse water, or peat-infused water, may then be separated from the peat solids. The peat rinse water may be referred to as a water-extracted peat compound. At least some of the peat rinse water may be mixed with the distilled liquor. The peat rinse water may be cooled prior to mixing with the distilled liquor. The peat rinse water may be mixed with the distilled liquor to bring the alcohol concentration of the distilled liquor to a desired level. Extracting the peat with water after contacting with the distilled liquor may impart additional flavors or more of the desired flavors, including herbal, earthy, umami, minerality, and slight hickory smoke-like aroma (without contacting with actual smoke), to the distilled liquor.

In some embodiments, at least a majority of the peat is removed from the distilled liquor after contacting the distilled liquor with the peat. In particular, at least a majority of the peat dry matter (e.g., the peat solids) may be separated from the distilled liquor after contacting the distilled liquor with the peat. The peat solids may be removed from the distilled liquor after contacting the distilled liquor with the peat by any suitable method. For example, the peat solids may be removed from the distilled liquor may be removed by filtration, decanting, centrifuging, or a combination thereof. It has been found that completely removing the peat dry matter from the distilled liquor may result in some loss of the peat flavor, while not removing enough may result in a gritty or chalky mouth feel and/or astringency or bitter flavor notes due to tannins. If the peat dry matter is removed by filtration, the filter pore size may be selected to result in a desired removal rate of the peat solids. In some embodiments, peat solids may be removed from the distilled liquor by filtration through a filter having a nominal pore size of 1 μm or greater, 2 μm or greater, 5 μm or greater, 10 μm or greater, 15 μm or greater, or 20 μm or less (e.g., a microfilter). In some embodiments, the filter has a nominal pore size of about 1 μm, about 2 μm, or about 5 μm. The peat solids may be removed from the distilled liquor by filtration through two or more filters that may have different nominal pore sizes. The different pore sizes may be in a range of 1 μm to 20 μm. The different pore sizes may include any combination of 1 μm, 2 μm, 5 μm, 10 μm, 15 μm, and 20 μm. When filtering distilled liquor through a microfilter, it may be useful to use a pump. Diaphragm pumps are known to be safe for use with flammable liquids, such as distilled spirits. However, the pressure pulses caused by the operation of the diaphragm pump may cause inconsistent filtration results. It may, therefore, be beneficial to use a pulsation smoothing device to absorb the pulses of the diaphragm pump and to help provide more consistent filtration.

However, some peat components may remain in the distilled liquor, such as certain peat flavor compounds. The peat components that remain in the distilled liquor may be referred to as the alcohol-extracted peat compounds. Some peat components may further be added to the distilled liquor by further extracting the peat with water and adding at least some of the thus formed peat rinse water, or peat-infused water, to the distilled liquor. Examples of peat flavor compounds may include certain resins, sterols, fatty acids, hydroxy acids, alkanes, long-chain alcohols, phenolic acids, and terpenoids typically found in peat. In one embodiment, the distilled liquor is contacted with peat for 3 days or longer (such as 1 to 3 weeks) and the contacted distilled liquor comprises one or more peat flavor compounds selected from resins, sterols, fatty acids, hydroxy acids, alkanes, long-chain alcohols, phenolic acids, and terpenoids. In one embodiment, the distilled liquor is contacted with peat for 24 hours or longer (such as up to 4 weeks) and the contacted distilled liquor comprises one or more peat flavor compounds selected from resins, sterols, fatty acids, hydroxy acids, alkanes, long-chain alcohols, phenolic acids, and terpenoids. In one embodiment, the distilled liquor is contacted with peat for 10 seconds to 30 minutes and the contacted distilled liquor comprises one or more peat flavor compounds selected from resins, sterols, fatty acids, hydroxy acids, alkanes, long-chain alcohols, phenolic acids, and terpenoids. In one embodiment, the peat is mixed with water and the mixture is heated, or the peat is contacted with hot water, and the water is subsequently mixed the distilled liquor. The peat that is mixed or contacted with water may be peat that has already been contacted with distilled liquor. This mixing or contacting with water may further extract secondary and/or water soluble flavor compounds from the peat.

In one or more embodiments, contacting the distilled liquor with peat may reduce the content of one or more compounds in the distilled liquor. More particularly, contacting the distilled liquor with peat may advantageously reduce the content of one or more undesirable compounds in the distilled liquor. Such undesirable compounds may typically be associated with hangovers after consuming distilled liquors or compounds associated with less desirable flavor profiles. Contacting the distilled liquor with peat may reduce the amount of low molecular weight (e.g., 200 g/mol or lower) carbonyl-containing compounds, for example, alkyl ketone containing compounds, acetates, aldehydes, and the like, in the distilled liquor. Examples of undesirable compounds that may be reduced in the distilled liquor by contact with peat include acetaldehyde (observed, e.g., to be associated with hangovers), acetone (observed, e.g., as providing chemically/harsh flavor), ethyl acetate (observed, e.g., as providing fruity flavor, which may be less desired and associated with “young-ness”), isoamyl acetate (observed, e.g., as providing banana and pear flavors, which may be less desired). Other compounds may also be reduced. The compounds may be reduced by 5% or more, 10% or more, 15% or more, 20% or more, 25% or more, 30% or more, 40% or more, 50% or more, or 60% or more, of the level prior to contact with peat. While there may not be a desired upper limit for the reduction, in practice, the compounds may be reduced by up to 90%, up to 80%, or up to 70% of the level prior to contact with peat.

The distilled liquor may be contacted with any suitable amount of peat to achieve a desired flavor profile. For example, the distilled liquor may be contacted with the peat at a ratio of 0.5 w/v-% or greater, 0.75 w/v-% or greater, 1.0 w/v-% or greater, 1.5 w/v-% or greater, 2 w/v-% or greater, 3 w/v-% or greater, 4 w/v-% or greater, 5 w/v-% or greater, or 6 w/v-% or greater of peat to distilled liquor. In some preferred embodiments, the distilled liquor is contacted with peat at a ratio of 3 w/v-% or greater, 4 w/v-% or greater, 5 w/v-% or greater, or 6 w/v-% or greater of peat to distilled liquor. The distilled liquor may be contacted with the peat at a ratio of 15 w/v-% or less, 12 w/v-% or less, 10 w/v-% or less, 8 w/v-% or less, 7 w/v-% or less, 6 w/v-% or less, 5 w/v-% or less, 4 w/v-% or less, 3.5 w/v-% or less, or 3 w/v-% or less of peat to distilled liquor. In some embodiments, the distilled liquor is contacted with the peat at a ratio of 3 w/v-% to 15 w/v-%, or 5 w/v-% to 10 w/v-% of peat to distilled liquor. The amount of peat given here may be the total amount of peat used to contact the distilled liquor. The peat may be divided into two or more amounts of peat. The two or more amounts of peat may be used to contact a volume of distilled liquor in consecutive contacting steps. In embodiments where the distilled liquor is contacted with the peat in multiple passes (e.g., circulated through a filter containing the peat), the total dosage may be calculated as the amount of peat multiplied by the number of passes.

After distillation and prior to contacting with peat, the distilled liquor may have an alcohol concentration of 40 vol-% or greater, 45 vol-% or greater, 50 vol-% or greater, 60 vol-% or greater, 70 vol-% or greater, or 80 vol-% or greater. In some cases, the fermented liquor is distilled to an alcohol concentration of about 90 vol-%. The distilled liquor may be mixed with water prior to contacting with peat to result in an alcohol concentration of 75 vol-% or less, 70 vol-% or less, 65 vol-% or less, 60 vol-% or less, 55 vol-% or less, 50 vol-% or less, or 45 vol-% or less. The distilled liquor may be mixed with water prior to contacting with peat to result in an alcohol concentration of 20 vol-% or greater, 30 vol-% or greater, 40 vol-% or greater, 45 vol-% or greater, 50 vol-% or greater, or 55 vol-% or greater. In some embodiments, the distilled liquor has an alcohol concentration of about 45 vol-% to about 65 vol-%, or about 48 vol-% to about 52 vol-% when contacted with peat. In some embodiments, the distilled liquor is at a first alcohol concentration when contacted with a first amount of peat and then at a second alcohol concentration with a second amount of peat. The second alcohol concentration may be lower than the first alcohol concentration. In some embodiments, a volume of distilled liquor is at a first alcohol concentration when contacted with an amount of peat. Then, the same peat is contacted with a second volume of distilled liquor at a second (different) alcohol concentration or with water. The peat is then removed from the second volume distilled liquor or the water, and the second volume distilled liquor or the water is mixed with the first volume of distilled liquor.

The method may further include aging the distilled liquor. In some embodiments, it is desired that the distilled liquor is in contact with wood during aging. This may conveniently be achieved by aging the distilled liquor in a wood cask or barrel. At least part of the inside surface of the wood cask or barrel may be charred. A portion of the aging may be conducted by storing the distilled liquor in a non-porous container, such as a stainless steel tank. Exposure of the distilled spirit to oxygen may be more limited during storage in a non-porous container than in a wood cask or barrel. The distilled liquor may be aged in a wood cask or barrel for a first period of time, such as about 1 to 4 weeks, and then stored in a non-porous container for a second period of time, which may be longer than the first period of time. In some embodiments, the aging is performed prior to contacting the distilled liquor with the peat. The distilled liquor may be mixed with water prior to aging to result in an alcohol concentration 75 vol-% or less, 70 vol-% or less, 65 vol-% or less, or 60 vol-% or less. The distilled liquor may be mixed with water prior to aging to result in an alcohol concentration 40 vol-% or greater, 45 vol-% or greater, 50 vol-% or greater, or 55 vol-% or greater. In one embodiment, the distilled liquor has an alcohol concentration of about 55 vol-% to about 65 vol-%, or about 58 vol-% to about 62 vol-% during aging. The aged distilled liquor (e.g., whiskey or other spirit) may be contacted with peat without further dilution with water. However, after having been contacted with peat, the aged distilled liquor (e.g., whiskey or other spirit) may be diluted with water to a desired alcohol content, such as about 35 vol-% to about 70 vol-%, 35 vol-% to about 60 vol-%, 35 vol-% to about 55 vol-%, or about 38 vol-% to about 50 vol-%. In one embodiment, the alcohol concentration of the distilled liquor is adjusted to a range of 40 vol-% to 60 vol-%, 45 vol-% to 55 vol-% or less, or to 50 vol-% or less prior to contacting with peat. The alcohol concentration of the distilled liquor may be further adjusted down to a desired final level after contacting with peat.

According to an embodiment, the distilled liquor, which includes at least alcohol and water, is mixed with peat. Thus, a composition is formed that is a mixture of distilled liquor and peat. The peat may include peat dry matter. The peat may include partially charred peat. However, the peat may include 5 wt-% or less, 10 wt-% or less, 25 wt-% or less, or 50 wt-% or less of inorganic carbon on a dry weight basis. The composition may include 40 vol-% or more of alcohol based on liquid components of the composition (for example, excluding peat dry matter). After a desired contact time (e.g., as discussed above), the peat may be removed, while leaving at least some flavor components in the distilled liquor. The peat may be removed, for example, by filtration, centrifugation, or any other suitable separation method. According to an embodiment, a distilled spirit includes a distilled liquor and an alcohol-extracted peat compound. The alcohol-extracted peat compound may include desired flavor components of the peat.

### EMBODIMENTS

The following is a list of exemplary embodiments according to the present disclosure.

Embodiment 1 is a method for making a distilled spirit, the method comprising: distilling a liquor comprising alcohol to form a distilled liquor; and contacting the distilled liquor with peat by: arranging the peat in a filter housing; and recirculating the distilled liquor through the peat to achieve a total dosage of 5 w/v-% or greater of the peat to the distilled liquor.

Embodiment 2 is a method for making a distilled spirit, the method comprising: distilling a liquor comprising alcohol to form a distilled liquor; and contacting the distilled liquor with peat by: mixing a first amount of the peat with the distilled liquor; mixing a second amount of the peat with the distilled liquor; and separating at least a majority of the first and second amounts of the peat from the distilled liquor.

Embodiment 3 is the method of embodiment 1 or 2, wherein the peat comprises peat dry matter.

Embodiment 4 is the method of any one of the preceding embodiments, wherein the peat comprises dried peat, wherein the dried peat has a moisture content of 25 wt-% or less, 20 wt-% or less, or 15 wt-% or less prior to being contacted with the distilled liquor.

Embodiment 5 is the method of any one of the preceding embodiments, wherein the peat comprises partially charred peat.

Embodiment 6 is the method of any one of the preceding embodiments, wherein the peat comprises 5 wt-% or less, 10 wt-% or less, 25 wt-% or less, or 50 wt-% or less, preferably 25 wt-% or less, most preferably 10 wt-% or less, of inorganic carbon on a dry weight basis.

Embodiment 7 is the method of any one of the preceding embodiments, wherein the peat is pre-wetted prior to being arranged in the filter housing, optionally wherein the peat is pre-wetted with the distilled liquor.

Embodiment 8 is the method of any one of the preceding embodiments, wherein the distilled liquor is recirculated through the peat for 3 passes or more, 4 passes or more, 5 passes or more, 6 passes or more, or 7 passes or more.

Embodiment 9 is the method of any one of the preceding embodiments, wherein the distilled liquor is recirculated through the peat for 20 passes or less, 15 passes or less, 12 passes or less, 10 passes or less, 8 passes or less, or 7 passes or less.

Embodiment 10 is the method of any one of the preceding embodiments, wherein the distilled liquor is contacted with the peat for 1 second or longer, 2 seconds or longer, 5 seconds or longer, 10 seconds or longer, 15 seconds or longer, 30 seconds or longer, 1 minute or longer, 10 minutes, 30 minutes or longer, 1 hour or longer, 6 hours or longer, 12 hours or longer, 24 hours or longer, 48 hours (2 days) or longer, 3 days or longer, 4 days or longer, or 1 week or longer; and for 48 hours or less, 24 hours or less, 12 hours or less, 6 hours or less, 2 hours or less, 1 hour or less, 30 min or less, 10 min or less, 5 min or less, 3 min or less, 2 min or less, or 1 min or less; preferably for 1 second to 1 hour or 5 seconds to 30 minutes, most preferably for 10 seconds to 10 minutes.

Embodiment 11 is the method of any one of the preceding embodiments, further comprising separating at least a majority of the peat from the distilled liquor.

Embodiment 12 is the method of any one of the preceding embodiments, wherein the peat comprises peat dry matter, and wherein the method further comprises separating the peat dry matter from the distilled liquor.

Embodiment 13 is the method of any one of the preceding embodiments, wherein the distilled spirit is free or substantially free of smoke, optionally wherein the distilled spirit is free or substantially free of smoke flavor.

Embodiment 14 is the method of any one of the preceding embodiments, wherein the method does not include contacting the distilled liquor with smoke or smoke flavor, wherein the method does not include contacting the distilled spirit with smoke or smoke flavor, or both.

Embodiment 15 is the method of any one of the preceding embodiments, further comprising aging the distilled liquor.

Embodiment 16 is the method of any one of the preceding embodiments, wherein the distilled liquor is in contact with wood during aging.

Embodiment 17 is the method of embodiment 15 or 16, wherein a portion of the aging is conducted by storing the distilled liquor in a non-porous container, optionally wherein the non-porous container comprises a stainless steel tank.

Embodiment 18 is the method of embodiment 16, wherein the distilled spirit is aged in a wood cask or barrel for a first period of time from about 1 to 4 weeks, and then stored in a non-porous container for a second period of time, wherein optionally the second period of time is longer than the first period of time.

Embodiment 19 is the method of any one of the preceding embodiments, wherein aging occurs prior to contacting the distilled liquor with the peat.

Embodiment 20 is the method of any one of the preceding embodiments, wherein the distilled liquor comprises alcohol at a concentration of 50 vol-% or greater, 60 vol-% or greater, 70 vol-% or greater, or 80 vol-% or greater.

Embodiment 21 is the method of any one of the preceding embodiments, wherein the distilled liquor is mixed with water prior to contacting with the peat to result in an alcohol concentration of 20 vol-% or greater, 30 vol-% or greater, 40 vol-% or greater, 45 vol-% or greater, or 50 vol-% or greater, or from 40 vol-% to 60 vol-%, 45 vol-% to 55 vol-%, or 48 vol-% to 52 vol-%.

Embodiment 22 is the method of any one of the preceding embodiments, wherein the distilled liquor is contacted with a first amount of the peat in a first contacting step and subsequently contacted with a second amount of the peat in a second contacting step.

Embodiment 23 is the method of embodiment 22, wherein the distilled liquor is at a first alcohol concentration during the first contacting step and at a second alcohol concentration during the second contacting step, optionally wherein the second alcohol concentration is lower than the first alcohol concentration.

Embodiment 24 is the method of embodiment 22, wherein during each of the first and second contacting steps, the distilled liquor is recirculated through the peat for 4 h to 12 h.

Embodiment 25 is the method of any one of the preceding embodiments, wherein after the contacting of the distilled liquor with the peat, the peat is collected and mixed with water to generate peat rinse water, and wherein at least some of the peat rinse water is mixed into the distilled liquor.

Embodiment 26 is the method of any one of the preceding embodiments, wherein before the contacting of the distilled liquor with the peat, the peat is collected and mixed with water to generate peat rinse water, and wherein at least some of the peat rinse water is mixed into the distilled liquor.

Embodiment 27 is the method of embodiment 25 or 26, wherein the collected peat is mixed with the water at a weight ratio of about 2:1 to 1:2, 1.5:1 to 1:1.5, or about 1:1 of peat solids to water.

Embodiment 28 is the method of any one of embodiments 25-27, further comprising heating the mixture of the collected peat and the water to an elevated temperature of 60° C. to 100° C., 80° C. to 100° C., or 90° C. to 99° C.

Embodiment 29 is the method of any one of the preceding embodiments, further comprising removing peat solids from the distilled liquor by filtration through a filter having a nominal pore size of 1 μm or greater, 2 μm or greater, 5 μm or greater, 10 μm or greater, 15 μm or greater, and up to 20 μm.

Embodiment 30 is the method of any one of the preceding embodiments, wherein the distilled spirit is a beverage suitable for human consumption, preferably wherein the distilled spirit comprises one or more peat flavor compounds selected from resins, sterols, fatty acids, hydroxy acids, alkanes, long-chain alcohols, phenolic acids, and terpenoids.

Embodiment 31 is a distilled spirit made with the method of any one of embodiments 1-30.

Embodiment 32 is a composition comprising:
a distilled liquor,
an alcohol-extracted peat compound; and
a water-extracted peat compound.

### EXAMPLES

### Example 1

The effect of filtering distilled liquor, prior to aging, through peat on the flavor profile of the resulting whiskey was evaluated.

Malted barley was ground and mashed by mixing with hot water. The grains were removed from the process liquid to prepare wort. The wort was cooled and fermented with yeast. The fermented liquor was distilled to about 90 vol-% of alcohol. The distillate was mixed with water to achieve 59.55 vol-% alcohol. The diluted distillate was filtered through a bed of granulated dried peat (prepared according to methods disclosed in U.S. Pat. No. 8,232,225) placed in a coffee filter. About 30 g of the granulated dried peat was used to filter about 475 mL of diluted distillate. The filtration rate was approximately 475 mL per 10 minutes, or about 48 mL/min. The temperature of the distillate was 70° F.

According to a sensory test of the filtered distillate, the resulting spirit had a delicate earthy, oily, herbal aroma and flavor. No smokiness was detected.

The filtered distillate was then added to a newly charred oak barrel of approximately 6.2 gallons volume. This filtered distillate was allowed to age for 4 months. The batch was diluted with water to 45 vol-% and bottled, and was again sensory tested.

Particulate matter was observed to have settled in each bottle, with clear whiskey above a cloudy, milky layer. Sensory testing found a normal flavor profile from the oak as expected. The fruity flavor profile from the peat was less pronounced after aging and the overall flavor profile was found to be close to a baseline (a non-peat-filtered whiskey).

### Example 2

Distillate was filtered as described in Example 1, except that the alcohol content of the distillate was adjusted to 54.95 vol-% (sample 1) and 55.55 vol-% (sample 2) prior to filtering.

The sensory results of samples 1 and 2 prior to aging in an oak barrel were similar to Example 1. Sample 1 was aged in an oak barrel with char level of “standard 4,” and sample 2 was aged in an oak barrel with char level of “standard 5,” a heavier char level.

Sensory testing revealed a darker color and a more pronounced roast flavor in each sample as compared to Example 1. The sensory test found that the peaty flavors carried over more but were also transformed in the barrel into new flavor profiles. The flavor descriptors used by the sensory panel included wet fur, cardboard, and phenolic flavors.

### Example 3

The effect of filtering aged whiskey through peat on the flavor profile of the whiskey was evaluated.

A distilled liquor was prepared as described in Example 1. The distilled liquor was adjusted with water to 60.05 vol-% alcohol and aged in an oak barrel for approximately 170 days. A filter bed was prepared by applying 100 g of granulated dried peat into a 3-foot tall stainless-steel tube.

The whiskey was filtered through the filter bed twice at a rate of about 1 gal per 10 minutes, or about 380 mL/min. The alcohol content of the filtered whiskey was adjusted to 43 vol-% prior to conducting a sensory analysis.

The sensory test found that the whiskey exhibited a normal organoleptic profile associated with a whiskey. In addition, flavors of the peat were noticeable and identifiable. The resulting whiskey had earthy, herbal, grassy, and floral profiles of peat, without smoky notes.

The filtered whiskey was bottled in 750 mL glass bottles and allowed to rest for 2-3 weeks. After resting, the whiskey retained its flavor profile. Some precipitate and a cloudy layer were found to have accumulated at the bottom of the bottle. However, clear whiskey could be decanted off the top into another bottle. The decanted whiskey did not develop a precipitate.

### Example 4

The effect of different moisture contents and levels of drying of the peat on the flavor profile of the whiskey was evaluated. Five different types of peat were obtained, prepared in ways to result in different moisture contents as shown in TABLE 1 below. All of the peat samples were harvested from Aitkin County, MN.

The processing methods included low-temperature oven drying at 170° F. for 6 hours (samples 1, 2, and 3), screening, rehydration, filter pressing, (samples 2, 3, and 4) drying in a rotary drum heater at 350° F. (sample 3 and 4), and the methods disclosed in U.S. Pat. No. 8,232,225 (sample 5).

TABLE 1
Peat samples.

| Sample number | Peat type/moisture content |
|---|---|
| 1 | Raw peat |
| 2 | Peat filter cake, 64% moisture |
| 3 | Dried peat pellets, 35% moisture |
| 4 | Dried peat pellets, 12% moisture |
| 5 | Granulated dried peat, 6% moisture |

0.3 g of each peat sample was soaked in 1.0 oz (about 30 mL) of 62.1 vol-% ethanol for two weeks. The samples, including the flavor profile imparted by the peat, were evaluated at the end of two weeks.

It was observed that raw peat left a large amount of haze and floating particulate matter in the ethanol. The amount of haze and particulate matter was gradually less for more processed peat samples, being almost absent from sample number 5. It was further observed that samples 1-4 imparted certain sulfurous flavor notes to the ethanol, with the raw peat (sample number 1) resulting in the most pronounced sulfur flavor. Sample number 5 did not impart significant flavors to the ethanol, including no unpleasant sulfur flavor.

### Example 5

The effect of the amount of peat and the duration of immersion were evaluated on the resulting flavor profile.

Granulated dried peat was immersed in aged whiskey (43 vol-% alcohol). The amount of peat varied from 1 g/dL (grams per deciliter) to 3 g/dL. 750 mL of whiskey was combined with the peat and placed in an Erlenmeyer flask. The samples were stirred for the first 8 hours, then rested for 16 hours. Aliquots of the samples were drawn at 24 hours for flavor profiling. The samples were further allowed to proceed for another four days, including 8 hours of stirring and 16 hours of resting each day. The samples were decanted using a pipette, and the flavor profiles of the samples were evaluated. The results are shown in TABLE 2 below.

TABLE 2
Flavor profiles.

| Amount | Flavor profile, | |
|---|---|---|
| of peat | Day 1 | Flavor profile, Day 5 |
| 1 g/dL | Mild floral | Floral, earthy, herbal |
| 2 g/dL | Mild floral, | Floral, earthy, herbal, |
| | fruity | slightly spicy, maple |
| 3 g/dL | Mild floral, | Floral, earthy, herbal, |
| | fruity and sweet | spicy, maple, mesquite, |
| | | hickory |

It was observed that both increased amount of peat and increased immersion time added more flavors to the resulting whiskey.

### Example 6

The effect of the duration of immersion was evaluated on the resulting flavor profile.

Granulated dried peat (1 g/dL) was immersed in aged whiskey (43 vol-% alcohol). Samples were stirred or shaken approximately every other day. Aliquots of the samples were drawn for flavor profiling at 1 week, 2 weeks, and 3 weeks. The results are shown in TABLE 3 below.

TABLE 3
Flavor profiles, amount of peat 1 g/dL.

| Time | Flavor profile |
|---|---|
| 1 week | Very mild effects, slight floral notes |
| 2 weeks | More pronounced effects, floral, earthy, and herbal |
| 3 weeks | Floral, earthy, and herbal, increased musty flavor |

### Example 7

Small production batches of whiskey were infused according to methods of the present disclosure and the resulting flavor profile was evaluated.

29 barrels, 5 gal each, of whiskey was produced by combining malted barley and hot water, then separating the resulting sugary liquor (wort) from the grain solids. Yeast was added to the wort and the liquid (now distiller's beer) was allowed to ferment for 7 days. The ferment was added to a 100 gallon hybrid column-reflux still and distilled to 170-180 proof (85-90 vol-%) alcohol. Distilled water was added to decrease proof to 120 (about 60 vol-%). The liquid (now raw make whiskey) was filled into barrels and sealed with a wooden bung and left to age in an environment with relatively stable temperature of 70° F. (about 21° C.) and humidity of 30-50%.

At the end of the aging period, granulated dried peat (30 g/L) was mixed in each barrel with the whiskey and allowed to infuse for 14 days. The barrels were agitated once per day by rolling back and forth. The barrels were dumped (a barrel dump is an industry term for processing barrels contents: the barrels are emptied, and the whiskey collected for further processing) and filtered by using an air diaphragm pump and pushed through a filter cartridge housing with 1 μm nominal pore size polypropylene filter cartridges made with thermally bonded sno-spun media. Samples were stirred or shaken approximately every other day. The whiskey was weighed, and reverse osmosis water added to bring the whiskey to 43 vol-% alcohol.

Aliquots of the whiskey were taken and the flavor was evaluated. The flavor was characterized as including notes of earthy, herbal, floral, spicy, mesquite, and maple.

### Example 8

A larger batch was prepared by combining 45 barrels (5 gal each) of whiskey into a 350 gal tote. Small production batches of whiskey were infused according to methods of the present disclosure and the resulting flavor profile was evaluated. Reverse osmosis water was added to dilute the alcohol concentration of the whiskey to 50 vol-%. Peat was added at a dosage of 30 g/L and agitated with a hanging agitator that uses an air driven motor at approximately 200 RPM. The whiskey was agitated every weekday and infused over a period of 9 days. It was observed that the peat flavor at this time was not as strong as was desired.

On the 10th day, an additional 10 g/L of the peat was added and agitated to boost the aroma and total peat flavor of the whiskey.

It was hypothesized that using a larger storage container with different contact area with the peat and with the air space resulted in less extraction of flavor from the peat than smaller batches.

### Example 9

A batch of whiskey was prepared as described in Example 8. An amount of peat to result in a dosage of 3 g/L was mixed with the whiskey (having an alcohol content of 50 vol-%) at a ratio of 1:1 by weight in a 20 L container, allowing the peat soak and expand. This prepared peat slurry was then be added into a 20 μm bag filter housing and used as a media bed for extracting the peat flavors. The whiskey was set up on a recirculation loop using an air diaphragm pump at about 5-7 gallons per minute and recirculated for 16 hours over the course of 2 days. Aliquots were taken every 2 hours of recirculation time. It was observed that after 8 hours, most flavors were extracted, and the peat recirculation could be ended.

The process was repeated with another amount of peat resulting in a second dosage of 3 g/L, recirculated for 8 hours, bringing the total (calculated) dosage to 46 g/L. It was observed that the whiskey had good peat aroma and flavor.

The spent peat from the recirculation was combined with reverse osmosis water at a ratio of 1:1 by weight. This peat and water slurry was put in a 20 gallon stainless steel pot and heated on an induction heat plate to 99° C. (210° F.). The liquid was then decanted off the peat and chilled using an ice bath. The peat-infused water, as well as plain reverse osmosis water, were used to reduce the alcohol concentration of the whiskey to 43 vol-% (86 proof). The peat-infused water was approximately 10% of the total proofing water.

The whiskey was filtered through a 5 μm filter cartridge using a diaphragm pump and a pulsation smoothing device to ensure a more steady flow rate. Use of the pulsation smoothing device allowed the use a larger size filter to reduce the peat solids to a target level so as to maximize flavor while avoiding haze or precipitate.

The resulting peat infused whiskey was tested by a panel of 9 taste testers. The taste testers used a 10-point scale to evaluate flavor notes including floral, fruit, phenolic, wood, grain, and off-flavors. The peat infused whiskey received similar marks to small batches such as those made in Example 7, but had a better phenol profile, reporting seashell and seaweed flavor notes as expected, and reporting no burnt or rubber phenols. It was concluded that the use of low proof water infusion resulted in increased peat aroma presence.

### Example 10

The effect of contacting distilled liquor with peat on the concentration of compounds in the distilled liquor was evaluated.

Whiskey samples were analyzed to measure the content of 10 byproducts that may typically be found in whiskey, for example, as byproducts of fermentation or distillation. The 10 byproducts measured are described in TABLE 4. In the table, some of the byproducts are described as typically being found in the “foreshots” or “heads.” These industry terms refer to early fractions of the distillate in batch distillation. Foreshots are characterized by relatively high content of methanol and acetone which are typically separated from subsequent fractions of the distillate, and may be discarded or further distilled. Heads are characterized by relatively high content of low-boiling compounds (e.g., primary alcohols, fusel alcohols, alkyls, ketone aldehydes, acetates, etc.).

TABLE 4
Measured byproducts.

| Chemical Name | Description |
|---|---|
| 1-propanol | A primary alcohol, sweet and flavorless. |
| Acetaldehyde | A primary cause of a hangover and is formed in |
| | fermentation, but also over time in the exposure to |
| | oxygen. |
| Acetone | A solvent contained in the foreshots and heads. |
| | Contributes harsh and chemically flavors. |
| Amyl alcohols | Fusel alcohols with a higher boiling point. Higher |
| | concentration in the heads. |
| Ethyl acetate | A common ester that contributes fruitiness and is |
| | associated with young-ness. |
| Ethyl butyrate | An ester that contributes a pineapple flavor. |
| Isoamyl acetate | An ester that contributes banana and pear. |
| Isobutanol | Contributes burnt chocolate and yeasty flavors |
| | typically associated with Irish whiskey. Described |
| | as rancid at high concentrations. |
| Isobutyl acetate | Contributes fruity and banana associated with some |
| | Scottish whisky. |
| Methanol | Toxic compound found in the foreshots. |

The amounts of the above compounds and their reduction in the whiskey as a result of contact with the peat were tested. The whiskeys analyzed included a whiskey prepared as described in Example 8 (“Control” sample) and the same whiskey after contact with peat at a rate of 3 g/dL as described in Example 5 (“Peated” sample). The results of analysis are shown in TABLE 5.

TABLE 5
Content of byproducts in samples.

| | Peated | Control | |
|---|---|---|---|
| Chemical Name | (ppm) | (ppm) | Reduction |
| Methanol | 67.9 | 69.0 | 2% |
| 1-propanol | 79.6 | 81.5 | 2% |
| Isobutanol | 660 | 683 | 3% |
| Amyl alcohols | 1180 | 1210 | 2% |
| Acetaldehyde | 43.3 | 48.7 | 11% |
| Acetone | 18.2 | 47.9 | 62% |
| Ethyl acetate | 343 | 514 | 33% |
| Isoamyl acetate | 7.44 | 9.91 | 25% |
| Isobutyl acetate | 0 | 0 | N/A |
| Ethyl butyrate | 0 | 0 | N/A |

It was observed that contacting the whiskey with peat afforded notable reductions in the content of four compounds that may be described as undesirable in distilled spirits. Acetaldehyde content, observed to contribute to hangovers, was reduced by approximately 11%. Acetone content, observed to contribute chemically and harsh sensory notes, was reduced by approximately 62%. Ethyl acetate, observed to contribute fruity and young sensory notes, was reduced by approximately 33%. Isoamyl acetate, observed to contribute banana and pair sensory notes, was reduced by approximately 25%.

It was concluded that contacting the whiskey with peat was particularly effective at reducing the amount of low molecular weight (e.g., 200 g/mol or lower) carbonyl-containing compounds, for example, alkyl ketone containing compounds, acetates, and aldehydes.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A method for making a distilled spirit, the method comprising:
distilling a liquor comprising alcohol to form a distilled liquor; and
contacting the distilled liquor with dried, granulated peat by:
arranging the peat in a filter housing; and
recirculating the distilled liquor through the peat to achieve a total dosage of 5 w/v-% or greater of the peat to the distilled liquor; and
separating at least a majority of the peat from the distilled liquor.

2. A method for making a distilled spirit, the method comprising:
distilling a liquor comprising alcohol to form a distilled liquor; and
contacting the distilled liquor with dried, granulated peat by:
mixing a first amount of the peat with the distilled liquor;
mixing a second amount of the peat with the distilled liquor; and
separating at least a majority of the first and second amounts of the peat from the distilled liquor.

3. (canceled)

4. The method of claim 1, wherein the peat comprises dried peat, wherein the dried peat has a moisture content of 25 wt-% or less.

5. The method of claim 1, wherein the peat comprises partially charred peat.

6. The method of claim 1, wherein the peat comprises 10 wt-% or less of inorganic carbon on a dry weight basis.

7. The method of claim 1, wherein the peat is pre-wetted prior to being arranged in the filter housing.

8. The method of claim 1, wherein the distilled liquor is recirculated through the peat for 3 to 20 passes.

9. (canceled)

10. The method of claim 1, wherein the distilled liquor is contacted with the peat for 1 second to 24 hours.

11. (canceled)

12. (canceled)

13. The method of claim 1, wherein the distilled spirit is free or substantially free of smoke and smoke flavor.

14. The method of claim 1, wherein the method does not include contacting the distilled liquor with smoke or smoke flavor, wherein the method does not include contacting the distilled spirit with smoke or smoke flavor, or both.

15. The method of claim 1, further comprising aging the distilled liquor, wherein the distilled liquor is in contact with wood during aging.

16-19. (canceled)

20. The method of claim 1, wherein the distilled liquor comprises alcohol at a concentration of 50 vol-% or greater.

21. The method of claim 1, wherein the distilled liquor is mixed with water prior to contacting with the peat to result in an alcohol concentration of 20 vol-% or greater.

22. The method of claim 1, wherein the distilled liquor is contacted with a first amount of the peat in a first contacting step and subsequently contacted with a second amount of the peat in a second contacting step.

23. The method of claim 22, wherein the distilled liquor is at a first alcohol concentration during the first contacting step and at a second alcohol concentration during the second contacting step.

24. The method of claim 22, wherein during each of the first and second contacting steps, the distilled liquor is recirculated through the peat for 4 h to 12 h.

25. The method of claim 1, wherein before or after the contacting of the distilled liquor with the peat, the peat is collected and mixed with water at a weight ratio of about 2:1 to 1:2 to generate peat rinse water, and wherein at least some of the peat rinse water is mixed into the distilled liquor.

26. (canceled)

27. (canceled)

28. The method of claim 25, further comprising heating the mixture of the collected peat and the water to an elevated temperature of 60° C. to 100° C.

29. The method of claim 1, wherein the separating comprises removing peat solids from the distilled liquor by filtration through a filter having a nominal pore size of 1 μm or greater.

30. The method of claim 1, wherein the distilled spirit is a beverage suitable for human consumption, and wherein the distilled spirit comprises one or more peat flavor compounds selected from resins, sterols, fatty acids, hydroxy acids, alkanes, long-chain alcohols, phenolic acids, and terpenoids.

31. A distilled spirit made with the method of claim 1.
